(19) United States
(12) Patent Application Publication
(10) Pub. No.: US 2021/0172343 A1
(43) Pub. Date: Jun. 10, 2021

(54) TURBINE MONITORING SYSTEM AND TURBINE MONITORING METHOD

(71) Applicants: KABUSHIKI KAISHA TOSHIBA, Tokyo (JP); TOSHIBA ENERGY SYSTEMS & SOLUTIONS CORPORATION, Kawasaki-shi (JP)

(72) Inventors: Tomohiko TSUKUDA, Yokohama Kanagawa (JP); Tsuguhisa TASHIMA, Yokohama Kanagawa (JP)

(73) Assignees: KABUSHIKI KAISHA TOSHIBA, Tokyo (JP); TOSHIBA ENERGY SYSTEMS & SOLUTIONS CORPORATION, Kawasaki-shi (JP)

(21) Appl. No.: 17/113,983

(22) Filed: Dec. 7, 2020

(30) Foreign Application Priority Data
Dec. 9, 2019 (JP) 2019-222427

(51) Int. Cl. F01K 13/00

(52) U.S. Cl. CPC F01K 13/003; F05D 2260/80; F05D 2220/31

(57) ABSTRACT

In one embodiment, a turbine monitoring system includes one or more measurers configured to sense a physical quantity of steam to be introduced to a steam turbine or exhausted from the steam turbine or water obtained from the steam exhausted from the steam turbine, and output a sensing result of the physical quantity. The system further includes a computing module configured to compute an erosion quantity of a moving vane of the steam turbine with water drops, based on the sensing result output from the one or more measurers. The system further includes a displaying module configured to display information that is based on the erosion quantity computed by the computing module.

### CROSS REFERENCE TO RELATED APPLICATION

This application is based upon and claims the benefit of priority from the prior Japanese Patent Application No. 2019-222427, filed on Dec. 9, 2019, the entire contents of which are incorporated herein by reference.

### FIELD

Embodiments described herein relate to a turbine monitoring system and a turbine monitoring method.

### BACKGROUND

Since in the low pressure stage of a steam turbine used for a power plant, the temperature and the pressure of steam, which is working fluid, go down in the process of the steam expanding, a part of the steam condenses into a moisture component in a steam channel.

FIGS. 11A and 11B are sectional views for explaining a problem of a conventional steam turbine. This steam turbine is exemplarily a low pressure turbine. FIGS. 11A and 11B show different cross sections of the low pressure turbine.

FIGS. 11A and 11B show the final stage, of the low pressure turbine, which is constituted of a pair of sets of stator vanes 1 and moving vanes 2 arranged downstream of the stator vanes 1, and a stator vane 3 and a moving vane 4, in the previous stage to the final stage, which have the same configurations of those. FIGS. 11A and 11B schematically show trajectories of steam and droplets (water drops) in a region including these stator vanes 1 and 3 and moving vanes 2 and 4.

In FIG. 11A, while steam, which is working fluid, traces trajectories as indicated streamlines L1, moisture components occurring until the previous stage to the final stage are in the form of water drops, and fly off along streamlines L2 with centrifugal force from a trailing edge end 5 of the moving vane 4 to a diaphragm outer ring 6 side of the stator vane 1.

When these water drops attach onto the stator vane 1, they flow on the surface of the stator vane 1 toward the tailing edge thereof while forming a water film DL on the surface, and when reaching a trailing edge end 7 of a turbine nozzle, they are put back into water drops to fly off. After that, the water drops collide around a leading edge end 8 of the moving vane 2.

FIG. 11B shows an absolute velocity V1 of the water drops, a relative velocity V2 of the water drops, and a peripheral velocity U of the steam. As shown in FIG. 11B, the absolute velocity V1 of the water drops flying off from the trailing edge end 7 of the stator vane 1 is smaller than the peripheral velocity U of the steam, and they are not to be accelerated enough by the time when they reach the moving vane 2. Therefore, the water drops are to collide against the backside of the leading edge end 8 of the moving vane 2 at the relative velocity V2 close to the peripheral velocity U. This collision between the droplets and the moving vane 2 causes erosion of the leading edge end 8 of the moving vane 2.

FIG. 12 is a graph for explaining the problem of the conventional steam turbine. FIG. 12 shows general relation between an erosion rate (“dE/dt”) and an elapsed time (“t”).

Periods during which the erosion rate is changing are categorized roughly into four periods of an incubation period, an acceleration period, a deceleration period and a stable period. In the incubation period, although significant decrease in weight does not occur on a material (for example, the moving vanes 2), damage caused by fatigue is being accumulated in the vicinity of the collision surface due to many water drops colliding thereagainst, which results in formation of fatigue cracks. In the acceleration period, the fatigue accumulated inside the material during the incubation period appears as fracture events, which rapidly increases the erosion rate. In the deceleration period, the erosion rate rapidly decreases, and in the stable period, the erosion rate has a certain constant value.

The erosion quantity “E” in the stable period is expressed as a property which linearly changes relative to time “t”, for example, by expression (1) below.

E=a+bt (1)

Herein, “a” is a material property. Differentiating expression (1) by time leads to the erosion rate “dE/dt”, which is an erosion quantity “E” per unit time and is expressed by expression (2) below.

dE/dt=b (2)

Herein, “b” is typically a function of a collision velocity of water drops, a water drop diameter, a water quantity (the number of water drops), and a material property and is expressed, for example, by expression (3) below.

b=C1×V^{p1}×d^{q1}×N (3)

Herein, “C1”, “p1” and “q1” are material constants, “V” represents the collision velocity, “d” represents the water drop diameter, and “N” represents the number of water drops.

Since erosion of the final stage harmfully affects reliability of the steam turbine, it is desirable to predict the erosion quantity in advance. Therefore, the erosion quantity is generally predicted in the stage of designing of a steam turbine, based on the theory as above, the operation states of the steam turbine being supposed.

### BRIEF DESCRIPTION OF THE DRAWINGS

FIG. 1 is a schematic diagram showing a configuration of a steam turbine plant of a first embodiment;

FIG. 2 is a flowchart for explaining operation of a turbine monitoring system of the first embodiment;

FIG. 3 is a schematic diagram showing a configuration of a steam turbine plant of a modification of the first embodiment;

FIG. 4 is a schematic diagram showing a configuration of a steam turbine plant of a second embodiment;

FIG. 5 is a flowchart for explaining operation of a turbine monitoring system of the second embodiment;

FIG. 6 is a schematic diagram showing a configuration of a steam turbine plant of a modification of the second embodiment;

FIG. 7 is a schematic diagram showing a configuration of a steam turbine plant of a third embodiment;

FIG. 8 is a sectional view for explaining operation of a steam turbine of the third embodiment;

FIG. 9 is a flowchart for explaining operation of a turbine monitoring system of the third embodiment;

FIG. 10 is a schematic diagram showing a configuration of a steam turbine plant of a modification of the third embodiment;

FIGS. 11A and 11B are sectional views for explaining a problem of a conventional steam turbine; and

FIG. 12 is a graph of for explaining the problem of the conventional steam turbine.

### DETAILED DESCRIPTION

Expanding use of renewable energy in recent years places, on the position of thermal power generation for supply-demand balancing, steam turbines, which are being wanted to be diversely operated (to be operated with partial load and to be suspended). Such diversity in operation causes properties at the moving vane inlet in the final stage of a steam turbine to fluctuate depending on conditions. It is therefore inferred that the collision velocity and the number of water drops mentioned above also change every hour depending on operations of a plant. One can accordingly consider that this makes the prediction of an erosion quantity difficult in the stage of designing of a steam turbine.

In one embodiment, a turbine monitoring system includes one or more measurers configured to sense a physical quantity of steam to be introduced to a steam turbine or exhausted from the steam turbine or water obtained from the steam exhausted from the steam turbine, and output a sensing result of the physical quantity. The system further includes a computing module configured to compute an erosion quantity of a moving vane of the steam turbine with water drops, based on the sensing result output from the one or more measurers. The system further includes a displaying module configured to display information that is based on the erosion quantity computed by the computing module.

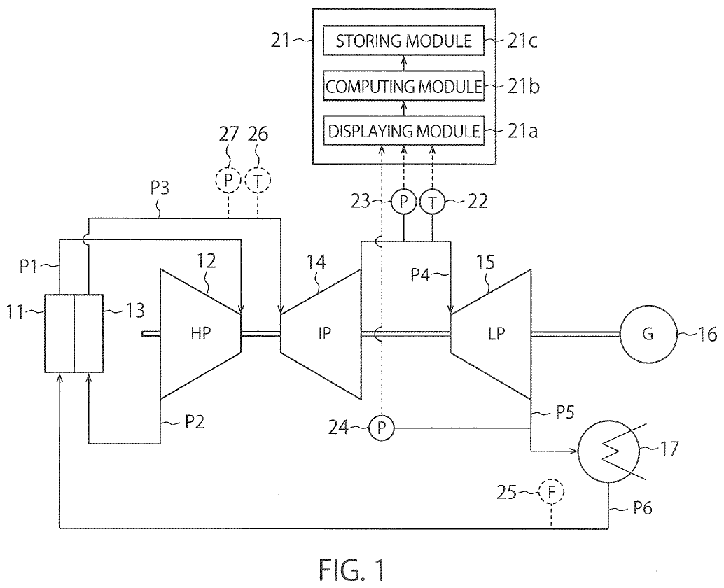

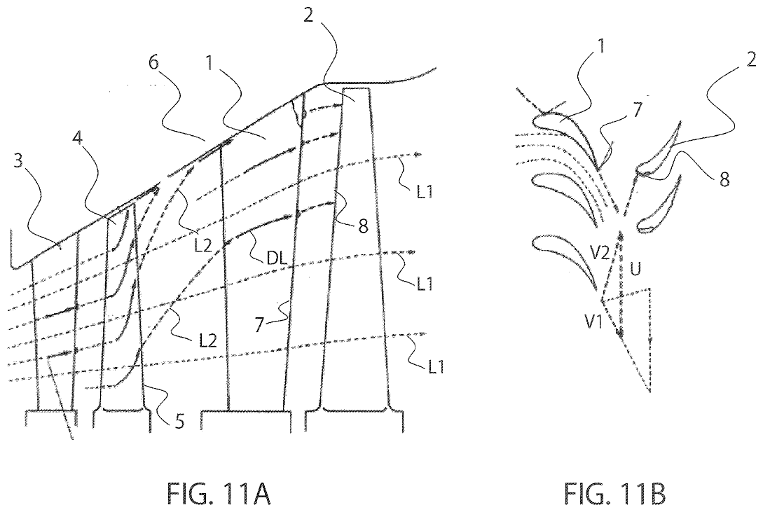

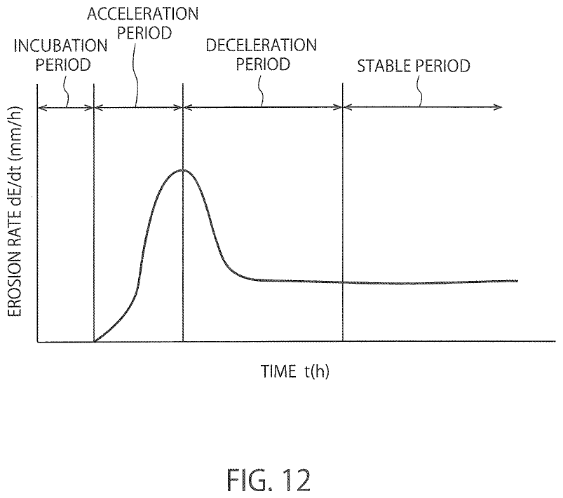

Embodiments will now be explained with reference to the accompanying drawings. In FIGS. 1 to 10 and aforementioned FIGS. 11A to 12, the same configurations are given the same signs and their duplicated description is omitted.

### First Embodiment

FIG. 1 is a schematic diagram showing a configuration of a steam turbine plant of a first embodiment.

The steam turbine plant in FIG. 1 is a plant of reheat type and includes a boiler 11, a high pressure (HP) turbine 12, a reheater 13, an intermediate pressure (IP) turbine 14, a low pressure (LP) turbine 15 which is exemplarily a steam turbine of the disclosure, a generator 16, a steam condenser 17, steam passages P1 to P5 and a water supply passage P6.

The steam turbine plant in FIG. 1 further includes, as components of a turbine monitoring system for monitoring operation of a steam turbine, a turbine monitoring device 21, an inlet temperature measurer 22, an inlet pressure measurer 23 and an outlet pressure measurer 24. The turbine monitoring device 21 includes a storing module 21a, a computing module 21b and a displaying module 21c. A flow rate measurer 25, an inlet temperature measurer 26 and an inlet pressure measurer 27 indicated in FIG. 1 with dotted lines are mentioned later.

The boiler 11 heats water to generate steam, and exhausts the steam to the steam passage P1. The high pressure turbine 12 is driven by the steam introduced from the steam passage P1, and exhausts the steam to the steam passage P2. The reheater 13 heats (reheats) the steam introduced from the steam passage P2, and exhausts the steam to the steam passage P3. The intermediate pressure turbine 14 is driven by the steam introduced from the steam passage P3, and exhausts the steam to the steam passage P4. The low pressure turbine 15 is driven by the steam introduced from the steam passage P4, and exhausts the steam to the steam passage P5. The generator 16 is driven by the high pressure turbine 12, the intermediate pressure turbine 14 and the low pressure turbine 15, and thereby, generates electric power. The steam condenser 17 cools the steam introduced from the steam passage P5 to put it back into water, and exhausts the water (condensed water) to the water supply passage P6. The boiler 11 heats the water (supplied water) introduced from the water supply passage P6 to generate steam, and exhausts the steam to the steam passage P1 as mentioned above. Steam and water circulate in the steam turbine plant as above.

The turbine monitoring device 21 is a device for monitoring operation of a steam turbine. The turbine monitoring device 21 is exemplarily a computer such as a PC (Personal Computer) or a controlling device such as a control panel. Details of the turbine monitoring device 21 are mentioned later.

The inlet temperature measurer 22 senses a temperature of the steam to be introduced to the low pressure turbine 15, and outputs the sensing result of the temperature to the turbine monitoring device 21. Specifically, the inlet temperature measurer 22 is provided on an inlet pipe (steam passage P4) installed upstream of the initial stage stator vanes of the low pressure turbine 15, and senses the temperature of the steam at an inlet of the low pressure turbine 15. The inlet temperature measurer 22 includes a thermocouple, for example, and outputs a thermoelectromotive current from the hot contact of the thermocouple installed in a flow field for measuring the temperature to the storing module 21a through a line (for example, a compensation lead wire). The inlet of the low pressure turbine 15 is an inlet of the initial turbine stage.

The inlet pressure measurer 23 senses a pressure of the steam to be introduced to the low pressure turbine 15, and outputs the sensing result of the pressure to the turbine monitoring device 21. Specifically, the inlet pressure measurer 23 is provided on the inlet pipe (steam passage P4) installed upstream of the initial stage stator vanes of the low pressure turbine 15, and senses the pressure of the steam at the inlet of the low pressure turbine 15. The inlet pressure measurer 23 includes a pressure conduit and a pressure sensor, for example, senses a pressure from the pressure conduit installed in a flow field for measuring the pressure with the pressure sensor, and outputs an output signal indicating the sensed pressure to the storing module 21a.

The outlet pressure measurer 24 senses a pressure of the steam exhausted from the low pressure turbine 15, and outputs the sensing result of the pressure to the turbine monitoring device 21. Specifically, the outlet pressure measurer 24 is provided on an outlet pipe (steam passage P5) installed downstream of the last stage moving vanes of the low pressure turbine 15, and senses the pressure of the steam at an outlet of the low pressure turbine 15. The outlet pressure measurer 24 includes a pressure conduit and a pressure sensor, for example, senses a pressure from the pressure conduit installed in a flow field for measuring the pressure with the pressure sensor, and outputs an output signal indicating the sensed pressure to the storing module 21a. The outlet of the low pressure turbine 15 is an outlet of the last turbine stage.

The storing module 21a stores the sensing result of the inlet steam temperature output from the inlet temperature measurer 22, the sensing result of the inlet steam pressure output from the inlet pressure measurer 23, and the sensing result of the outlet steam pressure output from the outlet pressure measurer 24. When the low pressure turbine 15 is operated, the storing module 21a of the present embodiment receives the output signal (thermoelectromotive current) from the inlet temperature measurer 22, the output signal from the inlet pressure measurer 23, and the output signal from the outlet pressure measurer 24 via an inputting and outputting module of the turbine monitoring device 21, and calculates averages of these output signals over a certain fixed operation time to output them to the computing module 21b.

The computing module 21b computes an erosion quantity of the moving vanes of the low pressure turbine 15 with water drops, based on the sensing result of the inlet steam temperature output from the inlet temperature measurer 22, the sensing result of the inlet steam pressure output from the inlet pressure measurer 23, and the sensing result of the outlet steam pressure output from the outlet pressure measurer 24. The computing module 21b of the present embodiment computes the erosion quantity of the moving vanes 2 in the final stage of the low pressure turbine 15 (refer to FIGS. 11A and 11B) with water drops, based on the signals output from the storing module 21a. The computing module 21b is implemented, for example, with a processor and a computer program, and the computer program executed by the processor computes the erosion quantity, based on signals and various data from the storing module 21a.

The displaying module 21c displays information that is based on the erosion quantity computed by the computing module 21b. The displaying module 21c displays such information, for example, on a display such as an LCD (Liquid Cristal Display) or indicators such as lamps. The displaying module 21c may display the information on a display or indicators of the turbine monitoring device 21 or may display the information on a display or indicators of another device connected to the turbine monitoring device 21 in a wired manner or a wireless manner.

The displaying module 21c of the present embodiment displays, as the information, the erosion quantity or a warning that is based on the erosion quantity. When displaying the erosion quantity, the displaying module 21c may display the erosion quantity computed by the computing module 21b in numerical values or may display the erosion quantity computed by the computing module 21b on a graph or a table. In such cases, the displaying module 21c may display the erosion quantity along with a reference value, for the erosion quantity, which is prestored in the turbine monitoring device 21 or in another device. Thereby, an administrator of the turbine monitoring system, for example, can be prompted to repair or replace moving vanes. Moreover, when the erosion quantity exceeds the reference value, the displaying module 21c may display a warning for prompting the administrator of the turbine monitoring system to repair or replace moving vanes on the display or the indicators. Examples of the warning include a message displayed on the display, and lighting a red lamp of the indicators.

The turbine monitoring system of the present embodiment monitors, as the steam turbine, the low pressure turbine 15. The reason is that the low pressure turbine 15 generally causes a problem of occurrence of erosion since the condition of steam becomes wet steam in turbine stages on its downstream side. It should be noted that the turbine monitoring system of the present embodiment may monitor a steam turbine other than the low pressure turbine 15.

The low pressure turbine 15 receives introduction of the steam from the steam passage P4. The steam from which expansion work has been taken out in the turbine stages of the low pressure turbine 15 passes through an exhaust chamber provided on the downstream side of the moving vanes 2 in the final stage of the low pressure turbine 15 and is exhausted to the steam passage P5. The steam exhausted to the steam passage P5 is introduced to the steam condenser 17 and put back into water. The low pressure turbine 15 is connected to the generator 16 as well as the high pressure turbine 12 and the intermediate pressure turbine 14 with a rotary shaft, and expansion work of the steam in these turbines is taken out as electric output of the generator 16.

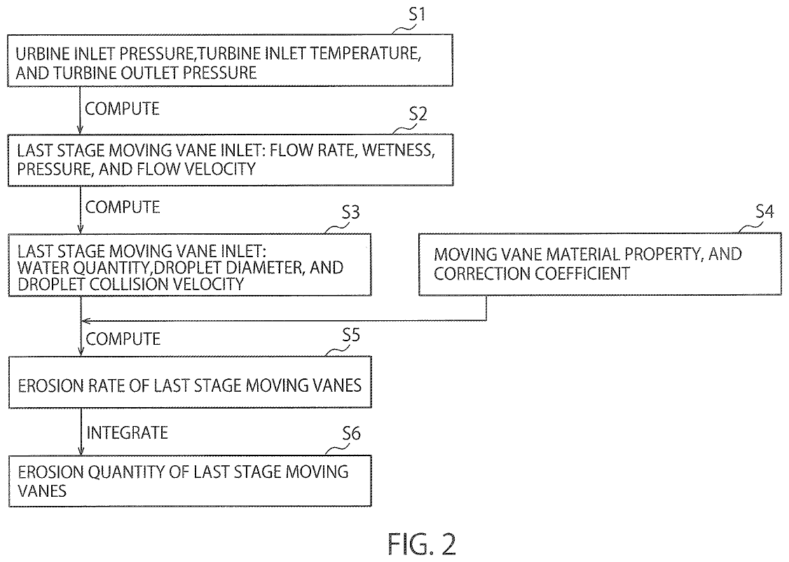

FIG. 2 is a flowchart for explaining operation of the turbine monitoring system of the first embodiment. FIG. 2 shows a flow of computations by the computing module 21b.

First, based on the turbine inlet pressure, the turbine inlet temperature and the turbine outlet pressure (S1) input from the storing module 21a, there are computed a flow rate, a wetness, a pressure and a flow velocity (S2) of steam at the last stage moving vane inlet of the low pressure turbine 15. In the present embodiment, a program for fluid analysis or one-dimensional steam calculation may be stored in the computing module 21b to calculate the flow rate, the wetness, the pressure and the flow velocity at the last stage moving vane inlet with the inlet pressure, the inlet temperature and the outlet pressure set as boundary conditions. Moreover, in the present embodiment, in order to reduce calculation capacity and load on the computing module 21b, the fluid analysis or the one-dimensional steam calculation on conditions supposed in actual operation may be performed comprehensively in advance to prestore relations between inputs and outputs thereto/therefrom above as approximation functions.

Next, from the flow rate, the wetness, the pressure and the flow velocity at the last stage moving vane inlet, there are next computed a water quantity (the number of water drops), a water drop diameter and a water drop collision velocity (S3) in the steam at the last stage moving vane inlet. The water quantity is calculated based on the aforementioned flow rate and wetness. The water drop diameter “D” is calculated using the pressure “ρ”, the flow velocity “W” and a Weber number “Weρ” by expression (4) below.

D=Weσ/(ρW²) (4)

The Weber number “Weρ” is a dimensionless number representing a ratio between inertia of steam and surface tension of water drops. The higher the pressure “ρ” is, the smaller the water drop diameter “D” is.

The collision velocity of water drops is calculated through trajectory calculation on the water drops from the aforementioned flow velocity and water drop diameter. Since as the water drop diameter is larger, the water drops are more scarcely accelerated with the steam and a difference in velocity between the steam and the water drops is larger, the collision velocity of the water drops against the moving vanes becomes higher. In the present embodiment, a trajectory analysis program on water drops may be stored in the computing module 21b to calculate the collision velocity of the water drops. Moreover, in the present embodiment, in order to reduce calculation capacity and load on the computing module 21b, the trajectory calculation on conditions supposed in actual operation may be comprehensively performed to prestore relations between inputs and outputs thereto/therefrom above as approximation functions in the computing module 21b.

Meanwhile, a material property and a correction coefficient (S4) of the last stage moving vanes are prestored in the computing module 21b. From the water drop collision velocity, the water quantity, the water drop diameter, the moving vane material property and the correction coefficient, the erosion rate “dE/dt” (S5), of the last stage moving vanes, which is expressed by expression (2) is evaluated, and then, the erosion quantity “ΔE” for a certain time range “Δt” is calculated using expression (5) below.

ΔE=dE/dt×Δt (5)

The erosion quantity “E” (S6) is calculated based on the erosion rate “dE/dt”. Specifically, the erosion quantity “E” is calculated by integrating “ΔE” computed using expression (5) over the operation time of the steam turbine plant. Namely, the erosion quantity “E” is calculated by integrating the erosion rate “dE/dt”. Thereby, the erosion quantity “E” of the last stage which the operation of the low pressure turbine 15 until the present is reflected on can be evaluated. Since the erosion rate “dE/dt” largely varies depending on the turbine inlet pressure, the turbine inlet temperature and the turbine outlet pressure of the low pressure turbine 15, “Δt” may be appropriately set depending on the frequency of change in properties of the low pressure turbine 15, and thereby, evaluation accuracy of the erosion quantity “E” can be enhanced.

Herein, advantages of the turbine monitoring system of the present embodiment are described.

As mentioned above, expanding use of renewable energy in recent years strongly places, on the position of thermal power generation for supply-demand balancing, steam turbines, which are being wanted to be diversely operated (to be operated with partial load and to be suspended). Such diversity in operation causes properties at the moving vane inlet in the final stage of a steam turbine to fluctuate depending on conditions. It is therefore inferred that the collision velocity and the number of water drops mentioned above change every hour depending on operations of a plant. One can accordingly consider that this makes the prediction of an erosion quantity difficult in the stage of designing of a steam turbine.

Therefore, in the present embodiment, the erosion quantity is calculated by computing the erosion rate of the last stage moving vanes in real time during operation of a turbine plant and integrating the erosion rate over the operation time thereof, in response to plant operation changing every time. Hence, according to the present embodiment, it is possible to evaluate the erosion quantity, of the last stage moving vanes, which the actual operation is reflected on with high accuracy. It is thereby possible to properly detect and/or predict the replacement timing and/or the repairing timing of the last stage, so that vanes can be prevented from coming apart due to erosion to improve reliability of the plant.

Hereafter, various modifications of the turbine monitoring system of the present embodiment are described. The following description can also be applied to second and third embodiments mentioned later.

While in the present embodiment, the erosion quantity “E” is calculated by integrating the erosion rate “dE/dt”, the erosion quantity “E” may be calculated by other methods. For example, the erosion quantity “E” may be calculated by other methods, other than integration, from the erosion rate “dE/dt” or the erosion quantity “E” may be calculated by not calculating the erosion rate “dE/dt” from the turbine inlet pressure, the turbine inlet temperature and the turbine outlet pressure.

Moreover, while in the present embodiment, the erosion quantity is calculated based on the turbine inlet temperature from the inlet temperature measurer 22, the turbine inlet pressure from the inlet pressure measurer 23, and the turbine outlet pressure from the outlet pressure measurer 24, the erosion quantity may be calculated from other physical quantities as in examples below.

In a first example, the erosion quantity is calculated using the turbine inlet temperature from the inlet temperature measurer 22, and the turbine inlet pressure from the inlet pressure measurer 23, not using the turbine outlet pressure from the outlet pressure measurer 24. There is, for example, a case where a choke arises at a throat part where the passage area at the last stage moving vanes of the low pressure turbine 15 is at its minimum, so that the property at the last stage moving vane inlet is constant even when the pressure is changing at the turbine outlet. In this case, the erosion quantity can be calculated not using the turbine outlet pressure from the outlet pressure measurer 24.

In a second example, the erosion quantity is calculated using the turbine inlet temperature from the inlet temperature measurer 22, a supplied water flow rate from the flow rate measurer 25 shown in FIG. 1, and the turbine outlet pressure from the outlet pressure measurer 24. The flow rate measurer 25 senses a flow rate of the water obtained from the steam exhausted from the low pressure turbine 15, and outputs the sensing result of the flow rate to the turbine monitoring device 21. Specifically, the flow rate measurer 25 is provided on a water supply pipe (water supply passage P6) installed downstream of the steam condenser 17, and senses the flow rate of the supplied water at an outlet of the steam condenser 17. For example, the flow rate measurer 25 outputs an output signal indicating the sensed flow rate to the storing module 21a. In this example, the supplied water flow rate is used since even using the supplied water flow rate in place of the turbine inlet pressure, the flow rate, the wetness, the pressure and the flow velocity at the last stage moving vane inlet can also be calculated.

In a third example, the erosion quantity is calculated using the turbine inlet temperature from the inlet temperature measurer 22 and the supplied water flow rate from the flow rate measurer 25, not using the turbine outlet pressure from the outlet pressure measurer 24. There is, for example, a case where a choke arises at a throat part where the passage area at the last stage moving vanes of the low pressure turbine 15 is at its minimum and the property at the last stage moving vane inlet is constant even when the pressure is changing at the turbine outlet. In this case, the erosion quantity can be calculated not using the turbine outlet pressure from the outlet pressure measurer 24.

While in the four techniques above, two kinds or three kinds of physical quantities are used, only one kind of physical quantity may be used or four or more kinds of physical quantities may be used as long as the erosion quantity can be computed. The number of measurer(s) outputting the sensing result(s) to the turbine monitoring device 21 for computing the erosion quantity may be one or four or more.

Moreover, in the four techniques above, the inlet temperature measurer 22 may be replaced by the inlet temperature measurer 26 shown in FIG. 1, and the inlet pressure measurer 23 may be replaced by the inlet pressure measurer 27 shown in FIG. 1. The reason is that physical quantities of the steam to be introduced to the low pressure turbine 15 can be evaluated from physical quantities of the steam to be introduced to the intermediate pressure turbine 14. The structures and operations of the inlet temperature measurer 26 and the inlet pressure measurer 27 are the same as those of the inlet temperature measurer 22 and the inlet pressure measurer 23 except that they are installed not on the steam pipe P4 but on the steam pipe P3.

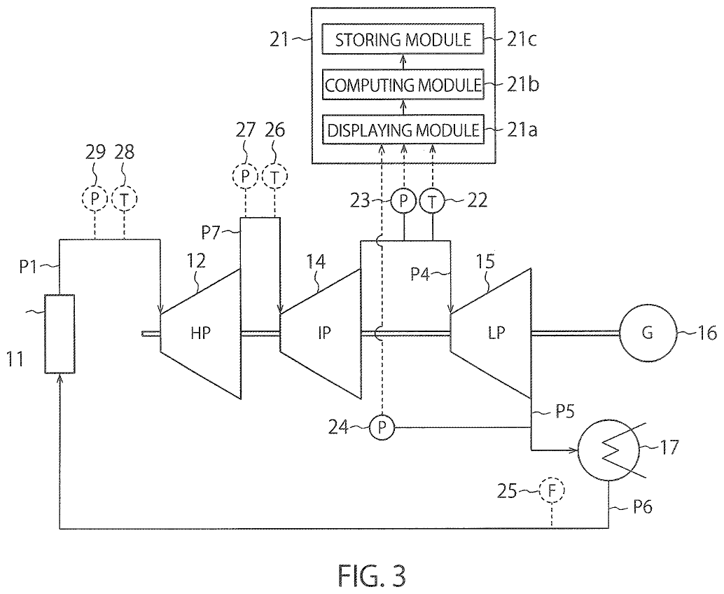

FIG. 3 is a schematic diagram showing a configuration of a steam turbine plant of a modification of the first embodiment.

The steam turbine plant in FIG. 3 is a plant of non-reheat type and is different from the steam turbine plant in FIG. 1 in that it does not include the reheater 13 and the steam passages P2 and P3 are replaced by a steam passage P7. In the present modification, the high pressure turbine 12 is driven by the steam introduced from the steam passage P1, and exhausts the steam to the steam passage P7. The intermediate pressure turbine 14 is driven by the steam introduced from the steam passage P7, and exhausts the steam to the steam passage P4.

In the four techniques above, the inlet temperature measurer 22 may be replaced by the inlet temperature measurer 28 shown in FIG. 3, and the inlet pressure measurer 23 may be replaced by the inlet pressure measurer 29 shown in FIG. 3. The reason is that since in the present modification, the steam exhausted from the high pressure turbine 12 is not reheated by the reheater 13, the physical quantities of the steam to be introduced to the low pressure turbine 15 can be evaluated from the physical quantities of the steam to be introduced to the high pressure turbine 12. The structures and operation of the inlet temperature measurer 28 and the inlet pressure measurer 29 are the same as those of the inlet temperature measurer 22 and the inlet pressure measurer 23 except that they are installed on the steam pipe P7, not on the steam pipe P4.

As above, in the present embodiment, the erosion quantity of the moving vanes of the low pressure turbine 15 is computed based on the sensing results output from the inlet temperature measurer 22, the inlet pressure measurer 23 and the outlet pressure measurer 24, and information that is based on the computed erosion quantity is displayed. Therefore, according to the present embodiment, the erosion quantity of the moving vanes of the low pressure turbine 15 can be appropriately evaluated.

Hereafter, steam turbine plants of the second and third embodiments are described. In the description below, their differences from the steam turbine plant of the first embodiment are mainly described and description of the matters common to them and the steam turbine plant of the first embodiment is omitted.

### Second Embodiment

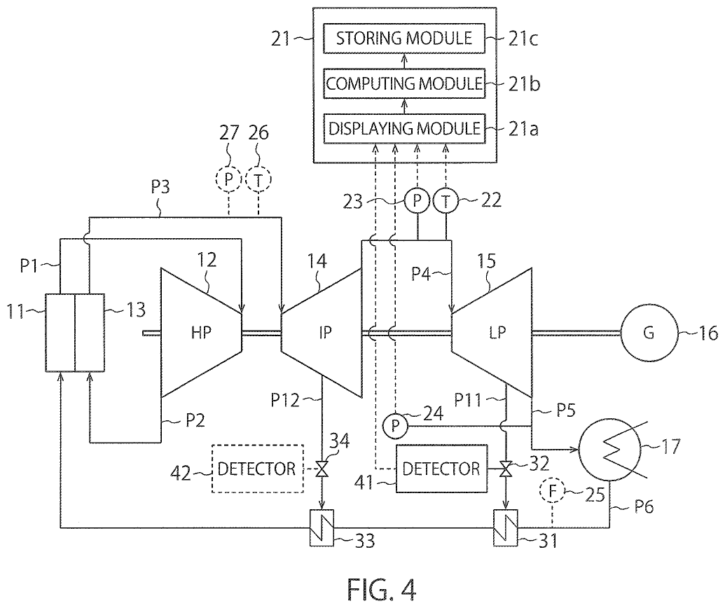

FIG. 4 is a schematic diagram showing a configuration of a steam turbine plant of the second embodiment.

The steam turbine plant in FIG. 4 is a plant of reheat type and includes supplied water heaters 31 and 33, extraction valves 32 and 34, an extraction detector 41 and steam passages P11 and P12 in addition to the constituents shown in FIG. 1. An extraction detector 42 presented by dotted lines in FIG. 4 is mentioned later.

The steam passage P11 is connected to the middle part of a steam channel part of the low pressure turbine 15 and is an extraction pipe for extracting the steam from an intermediate stage of the low pressure turbine 15. The supplied water heater 31 is installed on the water supply passage P6 and heats the supplied water flowing in the water supply passage P6 with extracted steam from the steam passage P11. The extraction valve 32 is installed on the steam passage P11 and used for regulating the steam flowing in the steam passage P11. When the extraction valve 32 is turned ON (opened), it extracts the steam from the low pressure turbine 15, and when the extraction valve 32 is turned OFF (closed), it stops extracting the steam from the low pressure turbine 15. The extraction valve 32 is exemplarily an extraction device of the disclosure.

The steam passage P12 is connected to the middle part of a steam channel part of the intermediate pressure turbine 14 and is an extraction pipe for extracting the steam from an intermediate stage of the intermediate pressure turbine 14. The supplied water heater 33 is installed on the water supply passage P6 and heats the supplied water flowing in the water supply passage P6 with extracted steam from the steam passage P12. The extraction valve 34 is installed on the steam passage P12 and used for regulating the steam flowing in the steam passage P12. When the extraction valve 34 is turned ON (opened), it extracts the steam from the intermediate pressure turbine 14, and when the extraction valve 34 is turned OFF (dosed), it stops extracting the steam from the intermediate pressure turbine 14. The extraction valve 34 is exemplarily the extraction device of the disclosure.

The extraction detector 41 detects operation of the extraction valve 32 and outputs the detection result of the operation of the extraction valve 32 to the turbine monitoring device 21. The extraction detector 41 of the present embodiment can detect the degree of opening of the extraction valve 32, and outputs an ON output signal when the extraction valve 32 is opened and an OFF output signal when the extraction valve 32 is closed, to the storing module 21a.

The storing module 21a stores the sensing results of the inlet steam temperature, the inlet steam pressure and the outlet steam pressure and stores an ON/OFF detection result of the extraction valve 32 output from the extraction detector 41.

The computing module 21b computes the erosion quantity of the moving vanes of the low pressure turbine 15 with water drops, based on the sensing results of the inlet steam temperature, the inlet steam pressure and the outlet steam pressure and the ON/OFF detection result of the extraction valve 32 output from the extraction detector 41.

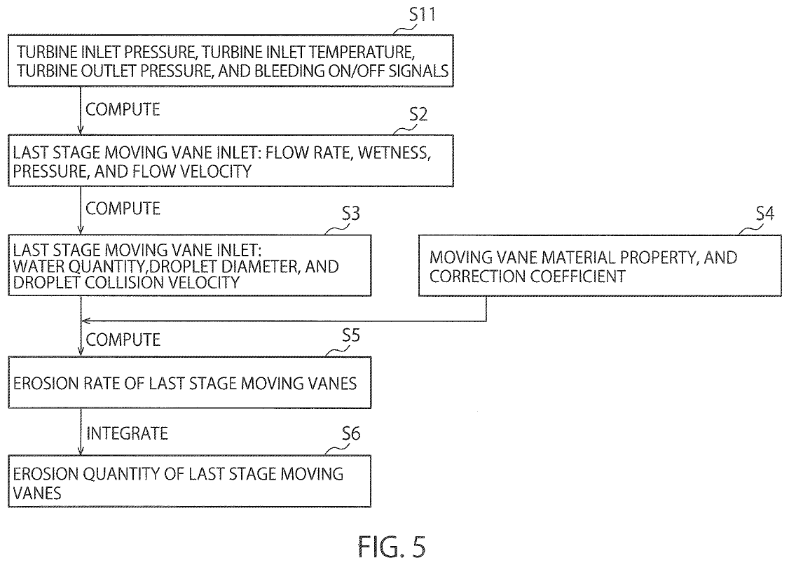

FIG. 5 is a flowchart for explaining operation of a turbine monitoring system of the second embodiment. FIG. 5 shows a flow of computations by the computing module 21b.

The flow of computations in FIG. 5 is similar to the flow of computations in FIG. 2. It should be noted that in the present embodiment, there are computed the flow rate, the wetness, the pressure and the flow velocity (S2) of the steam at the last stage moving vane inlet of the low pressure turbine 15, based on the turbine inlet pressure, the turbine inlet temperature, the turbine outlet pressure and an extraction ON/OFF signal (S1) input from the storing module 21a. The computation result in S2 in the case where extraction is turned OFF is the same as that in the case of the first embodiment. On the other hand, when extraction is turned ON, a steam flow rate at the last stage moving vane inlet decreases by a steam flow rate for extraction, and a steam pressure at the last stage moving vane inlet also decreases. Evaluating the erosion quantity in consideration of the presence or absence of extracting the steam from the low pressure turbine 15 as above can accordingly improve evaluation accuracy of the erosion quantity.

The inlet temperature measurer 22 may be replaced by the inlet temperature measurer 26 shown in FIG. 4, and the inlet pressure measurer 23 may be replaced by the inlet pressure measurer 27 shown in FIG. 4. In this case, the steam turbine plant of the present embodiment desirably includes not only the extraction detector 41 but also the extraction detector 42. The extraction detector 42 detects operation of the extraction valve 34 and outputs the detection result of the operation of the extraction valve 34 to the turbine monitoring device 21. The extraction detector 42 of the present embodiment can detect the degree of opening of the extraction valve 34, and outputs an ON output signal when the extraction valve 34 is opened and an OFF output signal when the extraction valve 34 is closed, to the storing module 21a. In this case, the computing module 21b computes the erosion quantity of the moving vanes of the low pressure turbine 15 with water drops, based on the sensing results of the inlet steam temperature, the inlet steam pressure and the outlet steam pressure and the ON/OFF detection results of the extraction valves 32 and 34 output from the extraction detectors 41 and 42. Evaluating the erosion quantity in consideration of the presence or absence of extracting the steam from the intermediate pressure and low pressure turbines 14 and 15 as above can accordingly improve evaluation accuracy of the erosion quantity.

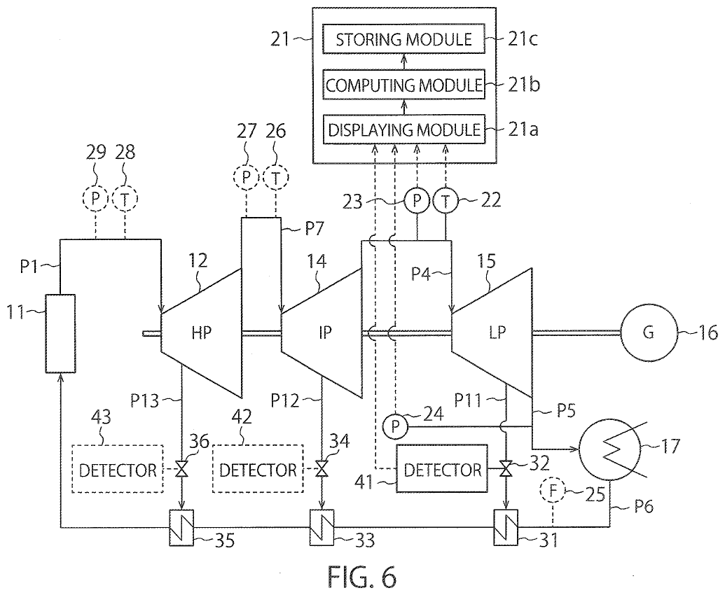

FIG. 6 is a schematic diagram showing a configuration of a steam turbine plant of a modification of the second embodiment.

The steam turbine plant in FIG. 6 is a plant of non-reheat type and is different from the steam turbine plant in FIG. 4 in that it does not include the reheater 13 and the steam passages P2 and P3 are replaced by the steam passage P7. The steam turbine plant in FIG. 6 further includes a supplied water heater 35, an extraction valve 36 and a steam passage P13.

The steam passage P13 is connected to the middle part of a steam channel part of the high pressure turbine 12 and is an extraction pipe for extracting the steam from an intermediate stage of the high pressure turbine 12. The supplied water heater 35 is installed on the water supply passage P6 and heats the supplied water flowing in the water supply passage P6 with extracted steam from the steam passage P13. The extraction valve 36 is installed on the steam passage P13 and used for regulating the steam flowing in the steam passage P13. When the extraction valve 36 is turned ON (opened), it extracts teh steam from the high pressure turbine 12, and when the extraction valve 36 is turned OFF (closed), it stops extracting the steam from the high pressure turbine 12. The extraction valve 36 is exemplarily the extraction device of the disclosure.

In the present modification, the inlet temperature measurer 22 may be replaced by an inlet temperature measurer 28 shown in FIG. 6, and the inlet pressure measurer 23 may be replaced by an inlet pressure measurer 29 shown in FIG. 6. In this case, the steam turbine plant of the present modification desirably includes not only the extraction detectors 41 and 42 but also an extraction detector 43. The extraction detector 43 detects operation of the extraction valve 36 and outputs the detection result of the operation of the extraction valve 36 to the turbine monitoring device 21. The extraction detector 43 of the present modification can detect the degree of opening of the extraction valve 36, and outputs an ON output signal when the extraction valve 36 is opened and an OFF output signal when the extraction valve 36 is closed, to the storing module 21a. In this case, the computing module 21b computes the erosion quantity of the moving vanes of the low pressure turbine 15 with water drops, based on the sensing results of the inlet steam temperature, the inlet steam pressure and the outlet steam pressure and the ON/OFF detection results of the extraction valves 32, 34 and 36 output from the extraction detectors 41, 42 and 43. Evaluating the erosion quantity in consideration of the presence or absence of extracting the steam from the high pressure, intermediate pressure and low pressure turbines 12, 14 and 15 as above can accordingly improve evaluation accuracy of the erosion quantity.

As above, in the present embodiment, the erosion quantity of the moving vanes of the low pressure turbine 15 is computed based on the sensing results output from the inlet temperature measurer 22, the inlet pressure measurer 23 and the outlet pressure measurer 24 and the detection result output from the extraction detector 41, and information that is based on the computed erosion quantity is displayed. Therefore, according to the present embodiment, the erosion quantity of the moving vanes of the low pressure turbine 15 can be appropriately evaluated also in consideration of extraction.

### Third Embodiment

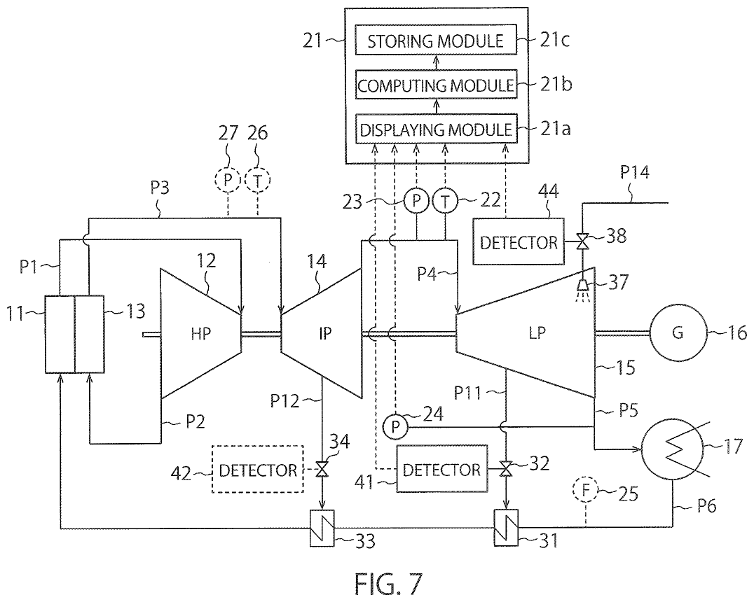

FIG. 7 is a schematic diagram showing a configuration of a steam turbine plant of the third embodiment.

The steam turbine plant in FIG. 7 is a plant of reheat type and includes an exhaust chamber spray 37, a cooling water valve 38, a spray detector 44 and a cooling water passage P14 in addition to the constituents shown in FIG. 4.

The cooling water passage P14 is a pipe for supplying cooling water to the low pressure turbine 15. The exhaust chamber spray 37 supplies the cooling water (spray water) from the cooling water passage P14 into an exhaust chamber provided downstream of the last stage moving vanes of the low pressure turbine 15. When the flow rate of the steam passing the last stage moving vanes of the low pressure turbine 15 is low and an exhaust chamber temperature excessively increases due to a stirring loss of the moving vanes, the exhaust chamber spray 37 may be turned ON, and thereby, the exhaust chamber temperature can be reduced. The cooling water valve 38 is installed on the cooling water passage P14 and used for regulating the cooling water flowing in the cooling water passage P14. When the cooling water valve 38 is turned ON (opened), it supplies the cooling water to the low pressure turbine 15, and when the cooling water valve 38 is turned OFF (closed), it stops supplying the cooling water to the low pressure turbine 15.

The spray detector 44 detects operation of the cooling water valve 38 and outputs the detection result of the operation of the cooling water valve 38 to the turbine monitoring device 21. The spray detector 44 of the present embodiment can detect the degree of opening of the cooling water valve 38, and outputs an ON output signal when the cooling water valve 38 is opened and an OFF output signal when the cooling water valve 38 is closed, to the storing module 21a.

The storing module 21a stores the sensing results of the inlet steam temperature, the inlet steam pressure and the outlet steam pressure and stores the ON/OFF detection result of the extraction valve 32 output from the extraction detector 41 and an ON/OFF detection result of the cooling water valve 38 output from the spray detector 44.

The computing module 21b computes the erosion quantity of the moving vanes of the low pressure turbine 15 with water drops, based on the sensing results of the inlet steam temperature, the inlet steam pressure and the outlet steam pressure, the ON/OFF detection result of the extraction valve 32 output from the extraction detector 41, and the ON/OFF detection result of the cooling water valve 38 output from the spray detector 44. In this stage, the computing module 21b computes the erosion quantity of the moving vanes with water drops caused by the steam in the low pressure turbine 15 and water drops caused by the spray water from the exhaust chamber spray 37.

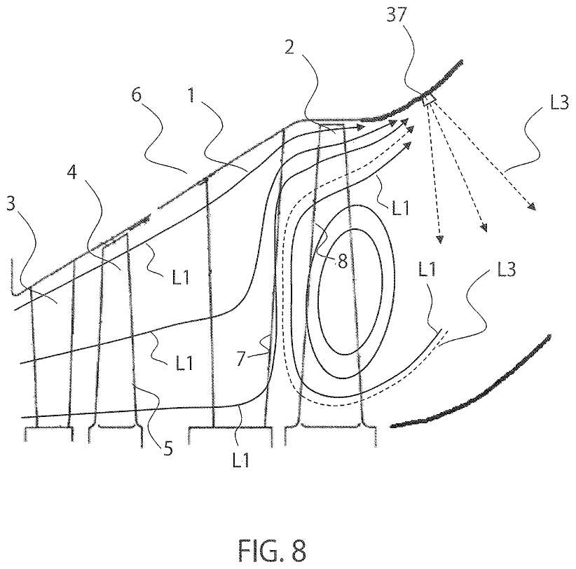

FIG. 8 is a sectional view for explaining operation of the steam turbine (low pressure turbine 15) of the third embodiment. FIG. 8 shows a cross section corresponding to that in FIG. 11A.

When the flow rate of the steam passing the moving vanes 2 in the final stage is low, there arises as shown in FIG. 8 a flow field along with a backflow from the exhaust chamber in the final stage. Curves L3 indicate flows of water drops sprayed from the exhaust chamber spray 37 in this case. The water drops sprayed from the exhaust chamber spray 37 flow back along the streamlines L1 of the steam into the final stage, through the base side of the moving vane 2, and flow outward in the radial direction along the streamlines L1 of the steam in the final stage. Therefore, the water drops sprayed from the exhaust chamber spray 37 are to collide with the leading edge of the moving vane 2, which causes the moving vane 2 to be eroded.

Namely, the moving vane 2 of the present embodiment is not only eroded with water drops caused by the steam in the low pressure turbine 15 but also eroded with water drops caused by the spray water from the exhaust chamber spray 37. Therefore, in the present embodiment, the erosion quantity of the moving vane 2 of the low pressure turbine 15 is computed in consideration of water drops of these two types.

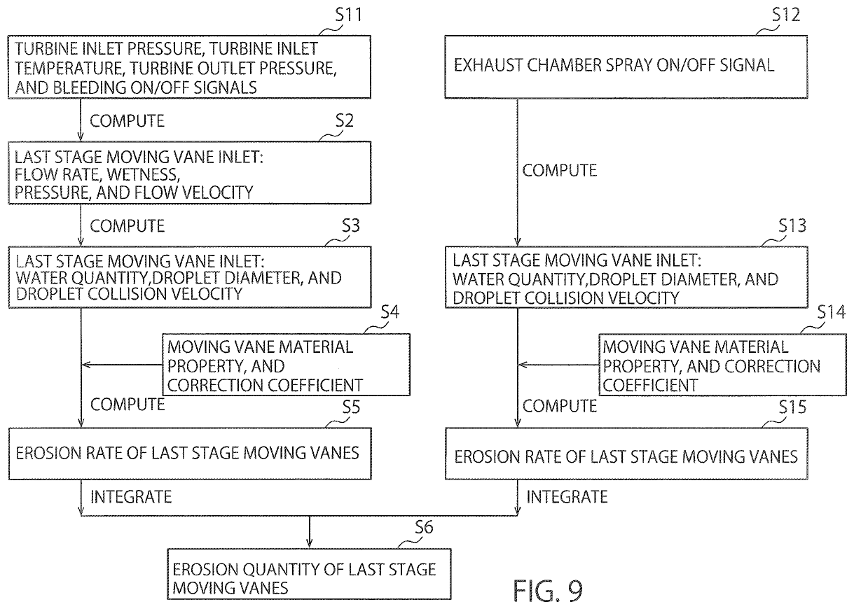

FIG. 9 is a flowchart for explaining operation of the turbine monitoring system of the third embodiment. FIG. 9 shows a flow of computations by the computing module 21b.

The computing module 21b performs processing regarding S11, S2, S3, S4 and 55 in FIG. 9 similarly to the case of FIG. 5.

Meanwhile, based on a spray ON/OFF signal (S12) input from the storing module 21a, the computing module 21b computes, as to the water drops caused by the spray, a water quantity (the number of water drops), a water drop diameter and a water drop collision velocity (S13) at the last stage moving vane inlet. In the present embodiment, the computing module 21b may prestore the number and the diameter of water drops sprayed from the exhaust chamber spray 37. Moreover, in the present embodiment, trajectory calculation on water drops sprayed from the exhaust chamber spray 37 may be performed in advance based on the number and the diameter of the water drops to store the collision velocity of droplets sprayed from the exhaust chamber spray 37 against the moving vane 2 in the computing module 21b.

Next, from the water quantity, the water drop diameter and the water drop collision velocity of water drops from the exhaust chamber spray 37 and the moving vane material property and the correction coefficient of the last stage moving vanes (S14), the erosion rate “dE/dt” of the last stage moving vanes (S15) due to the exhaust chamber spray 37 is evaluated using expression (2) above. The moving vane material property and the correction coefficient in S14 are the same as the moving vane material property and the correction coefficient in S4.

Next, the erosion quantity “ΔE” with water drops from the exhaust chamber spray 37 during a spray time “Δt” of the exhaust chamber spray 37 is calculated using expression (6) below.

ΔE=dE/dt×Δt (6)

The erosion quantity “E” of the present embodiment (S6) is calculated by summing up the erosion quantity with water drops contained in the working steam and the erosion quantity due to the exhaust chamber spray 37. For example, the former erosion quantity is calculated by integrating “ΔE” computed using expression (5) over the operation time of the steam turbine plant, and the latter erosion quantity is calculated by integrating “ΔE” computed using expression (6) over the operation time of the steam turbine plant. Then, the former erosion quantity and the latter erosion quantity are summed up, and thereby, the total erosion quantity “E” can be calculated. According to the present embodiment, evaluation of the erosion quantity in consideration of the influence of turning ON/OFF the exhaust chamber spray 37 in the low pressure turbine 15 can improve evaluation accuracy of the erosion quantity.

The inlet temperature measurer 22 may be replaced by the inlet temperature measurer 26 shown in FIG. 7, and the inlet pressure measurer 23 may be replaced by the inlet pressure measurer 27 shown in FIG. 7. In this case, the steam turbine plant of the present embodiment desirably includes not only the extraction detector 41 but also the extraction detector 42 similarly to the second embodiment. In this case, the computing module 21b computes the erosion quantity of the moving vanes of the low pressure turbine 15 with water drops, based on the sensing results of the inlet steam temperature, the inlet steam pressure and the outlet steam pressure and the ON/OFF detection results of the valves 32, 34 and 38 output from the detectors 41, 42 and 44. Evaluating the erosion quantity in consideration of the presence or absence of extracting the steam from the intermediate pressure and low pressure turbines 14 and 15 as above accordingly improve evaluation accuracy of the erosion quantity.

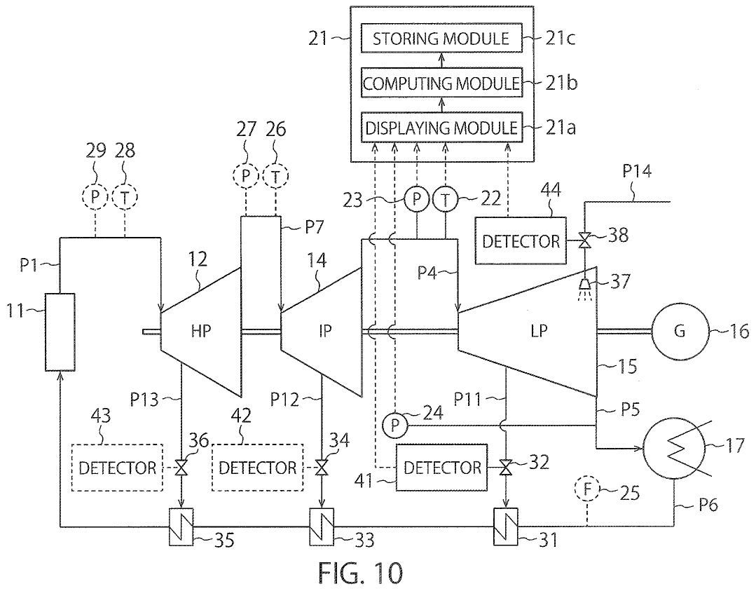

FIG. 10 is a schematic diagram showing a configuration of a steam turbine plant of a modification of the third embodiment.

The steam turbine plant in FIG. 10 is a plant of non-reheat type and is different from the steam turbine plant in FIG. 7 in not including the reheater 13 and in that the steam passages P2 and P3 are replaced by the steam passage P7. The steam turbine plant in FIG. 10 further includes the supplied water heater 35, the extraction valve 36 and the steam passage P13 similarly to the modification of the second embodiment.

In the present modification, the inlet temperature measurer 22 may be replaced by the inlet temperature measurer 28 shown in FIG. 10, and the inlet pressure measurer 23 may be replaced by the inlet pressure measurer 29 shown in FIG. 10. In this case, the steam turbine plant of the present modification desirably includes not only the extraction detectors 41 and 42 but also the extraction detector 43 similarly to the modification of the second embodiment. In this case, the computing module 21b computes the erosion quantity of the moving vanes of the low pressure turbine 15 with water drops, based on the sensing results of the inlet steam temperature, the inlet steam pressure the outlet steam pressure and the ON/OFF detection results of the valves 32, 34, 36 and 38 output from the detectors 41, 42, 43 and 44. Evaluating the erosion quantity in consideration of the presence or absence of extracting the steam from the high pressure, intermediate pressure and low pressure turbines 12, 14 and 15 as above can improve evaluation accuracy of the erosion quantity.

As above, in the present embodiment, the erosion quantity of the moving vanes of the low pressure turbine 15 is computed based on the sensing results output from the inlet temperature measurer 22, the inlet pressure measurer 23 and the outlet pressure measurer 24 and the detection results output from the detectors 41 and 44, and information that is based on the computed erosion quantity is displayed. Therefore, according to the present embodiment, the erosion quantity of the moving vanes of the low pressure turbine 15 can be appropriately evaluated also inconsideration of extraction and spraying.

While in the present embodiment, the exhaust chamber spray 37 and the spray detector 44 are provided in the steam turbine plant of the second embodiment, the exhaust chamber spray 37 and the spray detector 44 may be provided in the steam turbine plant of the first embodiment. Namely, the steam turbine plant of the present embodiment does not have to include the supplied water heater 31, the extraction valve 32, the extraction detector 41 or the like.

While certain embodiments have been described, these embodiments have been presented by way of example only, and are not intended to limit the scope of the inventions. Indeed, the novel systems and methods described herein may be embodied in a variety of other forms; furthermore, various omissions, substitutions and changes in the form of the systems and methods described herein may be made without departing from the spirit of the inventions. The accompanying claims and their equivalents are intended to cover such forms or modifications as would fall within the scope and spirit of the inventions.

1. A turbine monitoring system comprising:
one or more measurers configured to sense a physical quantity of steam to be introduced to a steam turbine or exhausted from the steam turbine or water obtained from the steam exhausted from the steam turbine, and output a sensing result of the physical quantity;
a computing module configured to compute an erosion quantity of a moving vane of the steam turbine with water drops, based on the sensing result output from the one or more measurers; and
a displaying module configured to display information that is based on the erosion quantity computed by the computing module.

2. The system of claim 1, wherein the computing module computes an erosion rate that is the erosion quantity of the moving vane with the water drops per unit time and computes the erosion quantity, based on the erosion rate.

3. The system of claim 2, wherein the computing module computes the erosion quantity by integrating the erosion rate over an operation time of the steam turbine.

4. The system of claim 1, wherein the computing module computes the erosion quantity of the moving vane in a final stage of the steam turbine with the water drops.

5. The system of claim 1, wherein the one or more measurers include:
a temperature measurer configured to sense a temperature of the steam to be introduced to the steam turbine; and
a first pressure measurer configured to sense a pressure of the steam to be introduced to the steam turbine.

6. The system of claim 1, wherein the one or more measurers include:
a temperature measurer configured to sense a temperature of the steam to be introduced to the steam turbine; and
a flow rate measurer configured to sense a flow rate of the water obtained from the steam exhausted from the steam turbine.

7. The system of claim 5, wherein the one or more measurers further include a second pressure measurer configured to sense a pressure of the steam exhausted from the steam turbine.

8. The system of claim 1, wherein the displaying module displays the erosion quantity or a warning that is based on the erosion quantity.

9. The system of claim 1, wherein the steam turbine is provided in a plant including a high pressure turbine, an intermediate pressure turbine and a low pressure turbine, and the steam turbine is the low pressure turbine.

10. The system of claim 1, further comprising an extraction detector configured to detect operation of an extraction device that extracts the steam from the steam turbine or another steam turbine, and outputs a detection result of the operation of the extraction device,
wherein the computing module computes the erosion quantity, based on the sensing result output from the one or more measurers and the detection result output from the extraction detector.

11. The system of claim 1, further comprising a spray detector configured to detect operation of an exhaust chamber spray that supplies water into an exhaust chamber of the steam turbine, and outputs a detection result of the operation of the exhaust chamber spray,
wherein the computing module computes the erosion quantity of the moving vane with water drops caused by the steam in the steam turbine and water drops caused by the water from the exhaust chamber spray, based on the sensing result output from the one or more measurers and the detection result output from the spray detector.

12. A turbine monitoring method comprising:
sensing, by one or more measurers, a physical quantity of steam to be introduced to a steam turbine or exhausted from the steam turbine or water obtained from the steam exhausted from the steam turbine, and outputting a sensing result of the physical quantity from the one or more measurers;
computing, by a computing module, an erosion quantity of a moving vane of the steam turbine with water drops, based on the sensing result output from the one or more measurers; and
displaying, by a displaying module, information that is based on the erosion quantity computed by the computing module.
